(19) United States
(12) Patent Application Publication
(10) Pub. No.: US 2011/0138523 A1
(43) Pub. Date: Jun. 16, 2011

(54) Flame, Heat and Electric Arc Protective Yarn and Fabric

(76) Inventors: Hoyt M. Layson, JR., Orlando, FL (US); Alceu Aragao, Miami, FL (US)

(21) Appl. No.: 12/708,552

(22) Filed: Feb. 19, 2010

Related U.S. Application Data
(60) Provisional application No. 61/286,111, filed on Dec. 14, 2009.
(60) Provisional application No. 61/298,061, filed on Jan. 25, 2010.

(51) Int. Cl. A62B 17/00; D03D 15/12; B32B 5/02; D04B 1/24; D03D 3/00

(52) U.S. Cl. 2/458; 442/199; 428/219; 66/171; 139/384 R

(57) ABSTRACT

This invention relates to flame, heat and electric arc protective yarn that can be used for knitting and weaving a single layer fabric. Both knitted and woven fabrics are for use as a single layer flame, heat and electric arc protective fabric garment or as an outer layer of a flame, heat and electric arc protective multiple layer garment or accessory for a wearer.

### RELATED APPLICATION DATA

This application claims priority to the following co-pending provisional applications: 61/298,061 (filed on Jan. 25, 2010) and 61/286,111 (filed on Dec. 14, 2009) both of which are entitled “Flame, Heat, and Electric Arc Protective Yarn and Fabric.” The contents of both these co-pending applications are fully incorporated herein.

### TECHNICAL FIELD

This disclosure relates to yarns and fabrics. More specifically, the disclosure relates to flame, heat and electric arc protective yarns that can be used for knitting and weaving single layer fabric for use in protective garments and accessories.

### BACKGROUND OF THE INVENTION

In many industries and professions there is a need for garments, gloves, aprons, coveralls, boots and hoods that provide an increase in flame, heat and electric arc protection. Examples are firefighters, flight line personnel, military pilots, steel mill workers, oil drilling field personnel, and refinery operators, welders and electrical workers. Typically these environments are not environmentally controlled so heavy protective clothing in the ambient temperature of the working conditions induces heat stress, fatigue and reduces productivity and reaction time of these workers. For example, a garment that protects firefighters against heat, flame and electric arc in fighting structural fires is also known as “Turn Out Coat”. A turn out coat is normally quite heavy because the multi-layer thickness of the garment that provides the heat, flame and electric arc protection. The bulk of the turnout coat therefore limits movement and induces heat stress so that the effectiveness of the firefighter decreases with fatigue caused by restricted freedom of movement.

Fabrics from which flame, heat and electric arc protective garments are constructed are required to pass a variety of overlapping US and international safety and/or performance standards, including NFPA 2112, NFPA 70E and MIL C 43829C. More stringent requirements for fabrics, such as airline blankets where the presence of fuel increases the heat of a fire can be found in FAA FAR 25.853.

Since flame, heat and electric arc protective garments are in harsh work environments they are subjected to more severe abrasion, rips and cuts than casual wear clothing. Any holes, rips or cuts in these protective garments compromises their effectiveness for the wearer and exposes undergarments and skin to heat, flame and electric arc hazards.

Currently the most flame, heat and electric arc resistant fibers are those which have already been chemically reduced and furnace oxidized. These fibers belong to a family known as PAN carbon fibers. PAN belongs to a family of acrylic precursors, which were developed by companies that were established commercial producers of textile grade acrylic fibers. Having a carbon content of up to 68%, PAN carbon fibers have excellent resistance to flame, heat and electric arc, but have extremely low resistance to abrasion, rips and cuts, thereby preventing effective application of 100% PAN carbon fibers to garments for harsh work environments. Even laundering in washing machines will cause rips and tears in PAN carbon fiber fabrics garments made from PAN carbon fibers because the fibers are so brittle due to the high carbon content.

Protective garments have also been made from natural cellulosic fibers, such as cotton. Natural cellulose fibers are inexpensive and fabrics made from such fibers are lightweight and comfortable to wear. However, cotton fibers are not durable and have poor abrasion, rip and cut properties. Although comfortable, cotton fibers are not inherently flame resistant and thus apt to burn. In order to provide flame, heat and electric arc protection, cotton fibers (or the yarns or fabrics made with such fibers) have historically been treated with a fire resistant (FR) compound to provide such fibers (or the yarns or fabrics made with such fibers) flame, heat and electric arc protective properties. Treatment of cotton fibers (or the yarns or fabrics made with such fibers) with an FR compound significantly increases the cost of such fibers (or the yarns or fabrics made with such fibers). The FR treatment is water soluble, therefore after 20+ launderings the FR properties are lost and the fabric no longer provides the protection as when the fabric was newly treated.

To mitigate the detrimental laundering effects on FR treated fabrics and to avoid the cost associated with FR fabric treatment, cotton fibers have been combined with modacrylic fibers that have inherent flame resistant properties. The modacrylic fibers control and counteract the flammability of the cotton fibers to prevent the cotton fibers from burning. Although modacrylic fibers have inherent FR properties, they also have low resistance to abrasion, rips and cuts similar to cotton, so these fabrics comprised of blends of these fibers have poor abrasion, rip and cut properties. In addition the yarns resulting from the blending of natural cotton fibers and modacrylic fibers are left unstable after thermal (flame or heat) exposure, so these fabrics will not pass the additional safety and performance certifications of thermal exposure cycling for protective garments.

In an attempt to address the stability of fabrics after thermal exposure, other inherently FR fibers, such as the aramid family of fibers, have been added to fiber blends for yarns to impart thermal stability to the blend to ensure compliance of the resulting fabric with the requisite safety and performance standards by decreasing charring dimensions, melting and fabric distortion and shrinkage in vertical flame tests of such fabrics. Because of the presence of natural and cotton fibers, the blended fabrics incorporating aramid fibers still lacked required properties for abrasion, rips and cuts.

Therefore, a need exists for fibers, yarns and fabrics that incorporate fibers that are more wear resistant than natural cellulosic fibers such as cotton for abrasion, rips and cuts, provide the cost and comfort advantages of natural fibers and protection from flame, heat and electric arcs.

### SUMMARY OF THE INVENTION

It is therefore one of the objectives of this invention to provide yarns that when woven in a simple pattern on conventional textile weaving machinery yield a durable monolayer fabric that will endure rigorous work environments and launderings without losing any desired and required protection properties.

It is another object of this invention to provide a monolayer design that offers levels of flame, heat and electric arc protection not available in current single layer fabrics of the same fabric weight and that are only available in fabrics of heavier weight and greater thickness or multi-layer fabrics.

Yet another object of this invention is to provide a simple construction of yarn that provides enhanced protection from flame, heat and electric arcs when knitted into garment accessories that require more flexibility, tactile feel and dexterity such as gloves and hoods.

The present invention thus discloses several techniques and methods regarding improved fibers, the optimal mechanical construction of fiber blends into staple yarns and staple yarns into composite yarns, and the most cost effective simple weaving patterns of yarns into woven dual ply monolayer fabrics as well as knitted fabrics to yield the desired properties of protection from flame, heat and electric arc resistance. The foregoing is accomplished while also achieving the additional properties of wear ability, lightweight monolayer fabric, flexibility and comfort with resistance to abrasion, rips and cuts.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a diagram illustrating the combustion mechanism of fibers.

FIG. 2 is a diagram illustrating the face side of a woven fabric warp and weft pattern.

FIG. 3 is a diagram illustrating the back side of a woven fabric.

FIG. 4 illustrates the Z direction of staple yarn (Y1) twist.

FIG. 5 illustrates the direction of composite yarn (TY1) twist.

FIG. 6 is a table of the Thermal Transition Temperatures of Fibers.

FIG. 7 is a table of NEMA insulation rations.

Similar reference characters refer to similar parts throughout the several views of the drawings.

### DETAILED DESCRIPTION OF THE INVENTION

Due to its unique structure of the yarn, the resulting fabric, knitted or woven, according to the present invention, surprisingly can have a range of specific fabric weight, which is lower than that of conventional flame, heat and electric arc protective fabrics having comparable durability and thermal properties when used as single layer fabric, knitted or woven, or as an outer layer fabric of a layered protective garment. The yarn of the present invention is designed to benefit not only woven fabrics but also knitted fabrics as well.

Thermal risks in fire situations against which human skin has to be protected may be due to:
Flames (convective heat)
Contact from hot solid objects (conduction heat).
High radiant temperature from localized source or from all around (Radiant heat).
Sparks, drops of molten metal, hot gases and vapors.
Electric arcs

Human tissue is very sensitive to temperature. When human tissue is exposed to any of the above hazards, the body experiences pain, second-degree and possibly third degree burns. Total heat energy as low as 0.64 cal/cm² (26.8 kJ/m²), results in a sensation of pain, and 1.2 cal/cm² (50.2 kJ/m²) causes second-degree burns on exposed tissues. At 45° C., the sensation of pain is experienced, and at 72° C. the skin is completely burnt. The mode of transfer establishes the means by which protection should be achieved. The rate of heat transfer is measured in terms of heat flux, which is the quantity of heat passing through unit area per second; it is expressed in kW/m². The measured heat flux determines the level of protection required. In order to achieve thermal protection the protective fabric/clothing should meet the following requirements.
Flame-resistance i.e. not change chemically or physically
Integrity i.e. not char, break, distort or melt
Insulation i.e. not directly transmit heat
Liquid-repellency i.e. not trap water which will turn to steam when heated

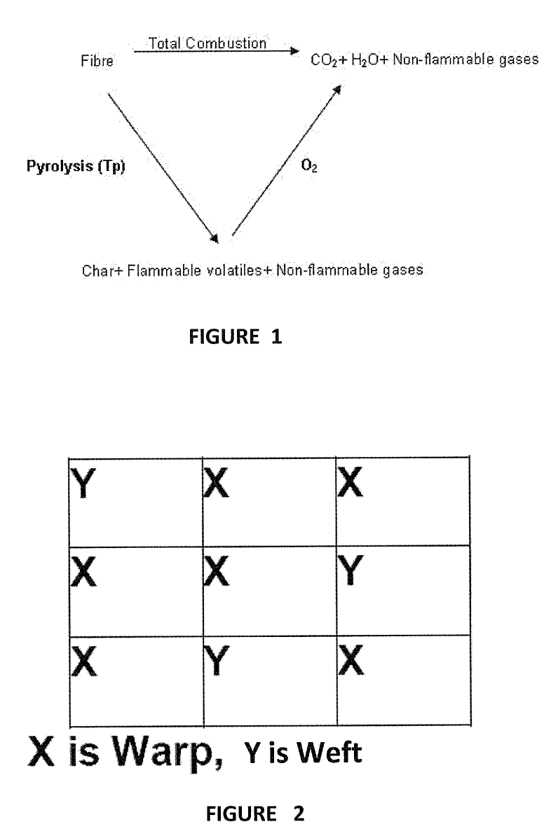

Heat's effect on a fiber can produce a physical (i.e. melting, charring, breaking) as well as a chemical change such as out gassing where the out gas component may lead to or accelerate combustion. In order to understand the protective function of the fabric and the garment, it is essential to understand the combustion mechanism of the fiber. FIG. 1 describes the combustion mechanism of fibers.

Fiber, yarn and fabric combustion is a complex phenomenon that involves heating, decomposition leading to gasification, ignition, and flame propagation. The rate of the initial rises in temperature of the fiber depends on the fiber specific heat, thermal conductivity, latent heat of fusion, vaporization or other enthalpy changes that occur during the combustion. In thermoplastic fibers, the physical changes are at second-order transition and subsequently melting occurs at a melting temperature, whereas chemical changes take place at temperature where thermal degradation (pyrolysis) occurs and the temperature where subsequent oxidation and combustion may occur. The different thermal properties of different fibers are listed in Table 1. Fibers undergo combustion when exposed to heat either directly or via the route of pyrolysis (Tp)-oxidation-combustion (Tc) as indicated in FIG. 1.

Conventional ways to change the combustion of fibers:
Treating the material with heat-absorbing products
Increasing the pyrolysis temperature makes the material heat-resistant i.e. inherently FR
Preventing evaporation, that is, to form non-volatile compounds in situ, called char
Eliminating the oxygen from the combustion zone preventing combustion

This invention proposes that selecting fibers with the most desired properties, then mechanically combining fibers into yarns, then mechanically combining yarns can yield enhanced desired properties beyond the desired properties of the fibers alone. Weaving and knitting patterns can also produce further enhancement of desired properties.

The flame resistance and retarding properties of the final textile material depends fundamentally on the nature of the fiber, then how fibers are arranged into yarns and the structure of the fabric. The nature of the fiber dictates its inherent tendency and ease of burning whereas the mechanical construction of fibers into yarns and then yarns into fabric composition shows different types of such constituents and gives an indication of the overall burning behavior. The structure of yarn and fabric decides the rate of burning and fabric construction, with the fabric weight playing an important an important role in typically deciding the suitability for different work wear applications.

The typical fabrics for work environments are listed below:
For a hot environment in which the fire hazard is principally a direct flame, a lightweight tightly woven construction such as 150-200 g/m² flame retardant (FR) cotton sateen, would normally be used.
A flame-retardant cotton twill of about 250-320 g/m² is recommended for a workshop in which the garment is subjected to a continuous shower of sparks and hot fragments as well as a risk of direct flame, a heavier fabric is required and a raised twill or velveteen of about 320-400 g/m² in FR cotton would normally be chosen.
Moreover, with molten metal splashes, the protection of the wearer against the heat flux resulting from the impact is also important. In such cases, fabric masses up to 900 g/m² are normally found useful.

Note that for existing FR fabrics, the weight of the fabric increases as the risk of 2^{nd} and 3^{rd} degree burns increases which adversely impacts user comfort, articulation, fatigue and mobility.

In the case of fire fighting, the immediate reflex action is to control an emergency as quickly as possible and at the same time take steps to minimize eventual damage to and loss of materials and injury to persons. The objectives of a fire fighter reaching an incident are to:
Save life and to prevent/minimize injury,
Prevent/minimize damage to property
Prevent or minimize damage to the environment.

The role of the fire fighters' personal protective clothing is not only to protect the fire fighter but also to enable the fire fighter to achieve above mentioned objectives. The type of protective garments and the protection the garment offers are selected on the basis on the degree of risk involved; fire-fighting protective garments are classified as:
Protective garments for structural fire fighting or “Turn Out Coat”
Fire Entry suits or Bunker Suits.
   Typically these suits are multi-layered:
Outer Shell—Usually a blend of Nomex, Kevlar and PBI. The outer shell is the first line of defense for flame, heat and electric arc protection and protects the inside layers from damage and this layer is the scope of this invention.
Moisture Barrier—Usually Gortex or Neoprene on cotton/polyester to prevent water transfer to the firefighter's skin.
Thermal Barrier—Usually a quilted material comprising a batt of aramid fibers.

Ergonomics is the important aspect that needs to be considered, especially in performance garments such as firefighter garments. On an action field, lots of body movement takes place, which puts lots of stress on the body if the garment is heavy and restricts movement. When the outer shell provides better flame, heat and electric arc protection, the other layers can be reduced in thickness and weight generating less stress on the firefighter.

Understanding the fundamental properties of a plurality of fibers and then uniquely arranging the fibers mechanically offers a composite yarn with the desired properties of the plurality of fibers which then allows fabrics, woven and knitted, to better leverage those desired properties. The additional mechanical properties of the weaving and knitting process, i.e. different patterns of weaves and knits, can further enhance the desired properties to yield a fabric optimized for the flowing properties:
Protection from flame and heat
Protection from electric arc
Durability properties:
   Abrasion resistance
   Rip resistance
   Cut resistance
   Laundering resistance
Lighter weight
Better comfort
Easier movement

The yarn of the present invention is comprised of meta-aramid, para-aramid and anti-static fibers. The unique method and technique of mechanically combining these fibers in certain weight percentage ranges disclosed herein produces a yarn that provides the unique combination of desired and enhanced desired properties described above. Further mechanical weaving of this yarn disclosed herein enhances these desired properties further.

Meta-aramid, poly(meta-phenyleneisophthalamide), is an aromatic polyamide fiber. The processes for manufacturing meta-aramid fibers have been Patented and Trademarked under the names Nomex, Teijinconex, Kermel, X-Fiper and New Star. Regardless of the process, the meta-aramid family of fibers possess excellent physical and mechanical properties and can be dope dyed offering a wide color range. Meta-aramid fibre, especially the copolyamide type, offers outstanding heat resistance, being resistant to melting even after many hours of exposure to heat. This thermal durability prevents the fiber from breaking down after initial and continued thermal exposure. 75% of original strength is retained after exposure to dry-heat of 200° C. for 1000 hours. 60% of original strength is retained after exposure to wet-heat at 120° C. for 1000 hours. The Limiting Oxygen Index (LOI) for Meta-aramid fiber is over 28%. It is a flame retardant fibre that will not burn, melt or drip. Above 370° C. meta-aramid fiber will start to carbonize and decompose. Meta-aramid fiber has excellent heat insulating properties to reduce the amount of transmitted heat through the fabric. These properties and its high dielectric strength enable NEMA (National Electrical Manufacturers Association) Class-H (Up to 180° C.) insulative property yarns to be produced. This property is key for protecting the skin against 2^{nd} and 3^{rd} degree burns. Table 2 provides the NEMA insulation ratings. Meta-aramid fibre's low stiffness and high elongation give excellent textile-like properties and characteristics for comfort, allowing processing on all types of conventional textile equipment for making woven and knitted fabrics. Meta-aramid fibre shows good resistance to α,β and ultraviolet radiation. For example, when meta aramid fiber is exposed at 1000 Mrad of β radiation accumulation, it shows no loss of strength. This extremely beneficial for outdoor work environments where ultraviolet sunlight radiation breaks down garment fibers making them brittle and reducing the level of flame, heat and electric arc protections due to openings in the fabric created by abrasion, rips and cuts. Certain work environments, such as welding, generate large amounts of ultraviolet radiation where welding occupation requires flame, heat and electric arc protection. Although meeting many of the desired requirements for flame, heat and electric arc protective apparel, at 370° C. meta-aramid fibers will carbonize, become brittle, break and will become weaker to abrasion, rips and cuts exposing undergarments, underlayers or skin to flame, heat and electric arc hazards.

Para-aramid, poly-(p-phenylenterephtalamid), is also an aromatic polyamide fiber. The processes for manufacturing meta-aramid fibers have been Patented and Trademarked under the names Kevlar, Technora, and Twaron. Aramids belong to the fiber family of nylons. Common nylons, such as nylon 6,6, do not have very good structural properties, so the para-aramid distinction is important. The aramid ring gives Kevlar thermal stability, while the para structure gives it high strength. Para-aramid fibers however are very difficult to dye.

The tensile modulus and strength of para-aramid is roughly comparable to glass, yet its mass is almost half that of glass. Para-aramid can be substituted for glass where lighter weight is desired. Para-aramid has other advantages besides weight and strength. Para-aramid has a slightly negative axial coefficient of thermal expansion, which means para-aramid composites can be made thermally stable. Para-aramid is very resistant to impact and abrasion damage making it useful as a protective layer such a ballistic protection vests. Therefore para-aramids can also be mixed with other fibers in fabrics to provide damage resistance, increased strain resistance, and to prevent catastrophic thermal failure modes. Para-aramid has a thermal conductivity of 0.30 BTU—in/hr² per ° F. as opposed to meta-aramid at 0.26 BTU—in/hr² per ° F. Para-aramid fibers are also very difficult to cut.

Para-aramids have a few disadvantages for flame, heat and electric arc protective clothing. Para-aramid fibers absorb moisture, so para-aramids are more sensitive to moisture in the environment, especially during laundering. Although para-aramid tensile strength is high, its compressive properties are relatively poor.

The yarn fabric of the present invention has particularly good mechanical properties due to the unique mechanical structure of the yarn. Generally speaking, the larger the amount of para-aramid fibers, the better the physical performance and resistance of the fabric itself to break open during thermal exposure. Preferably, the para-aramid fibers constitute from 65 to 90 wt-% (percentage weight) of the overall weight of the fabric. The meta-aramid fibers constitute from 33 to 8 wt-% (percentage weight) of the overall weight of the fabric with the remaining 2 wt-% (percentage weight) being antistatic yarn.

Because of the ideal properties of the yarn, a single yarn can be used to produce both knitted and woven fabrics without the need for complex ordering of multiple yarns or complex knitting or weaving patterns, each with different properties to achieve desired properties or differences in the level of protection. Since a common yarn is used there is also no difference in properties related to the face or back side of the fabric.

Therefore, according to a preferred embodiment of the present invention, advantageously the warp and weft systems of the woven fabric and the yarn for knitted fabric are based on the same twisted yarn making the properties of para-aramid available to all exposed surfaces of knitted and woven fabrics.

Furthermore, the fabric according to the present invention can be manufactured under standard process conditions by using conventional machines for weaving or knitting double ply single layer structures, thus rendering its production easier and more cost efficient. Single layer fabrics offer increased comfort and induce less stress on the wearer during periods of physical activity.

The staple yarn (Y1) is a ring spun staple yarn consisting of: 8 to 33 wt-% poly-m-phenylenisophtalamid (meta-aramid) fiber, 65 to 90 wt-% poly-p-phenylenterephtalamid (para-aramid) fiber, and 2 wt-% anti-static stainless steel fiber wrapped in a carbon core polyamide sheath with a twist from 480 to 950 turns per meter (TPM) in the Z direction. FIG. 4 depicts the Z direction of the ring spun yarn.

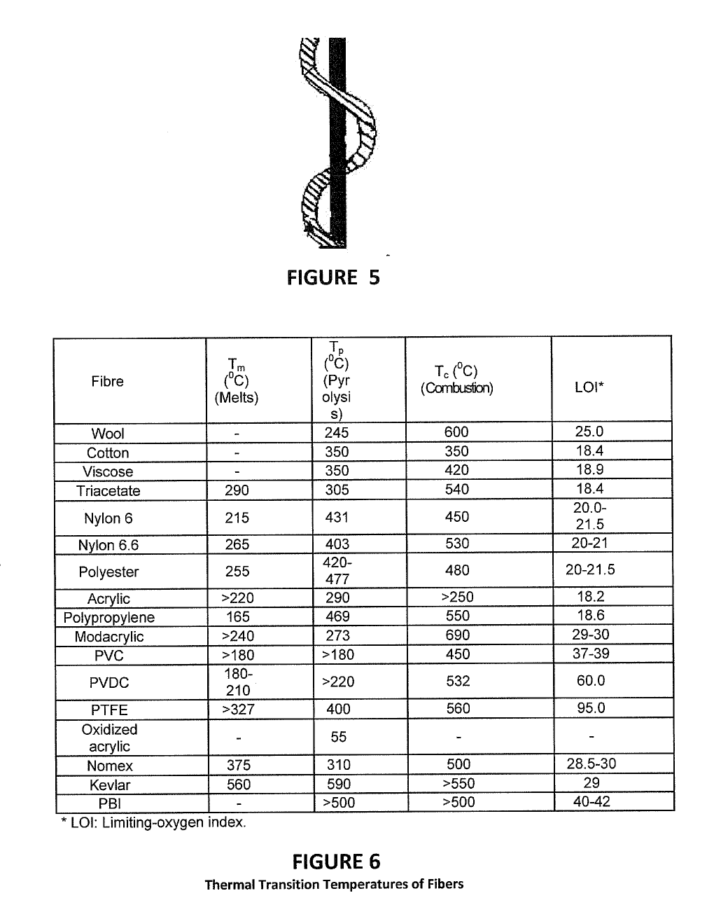

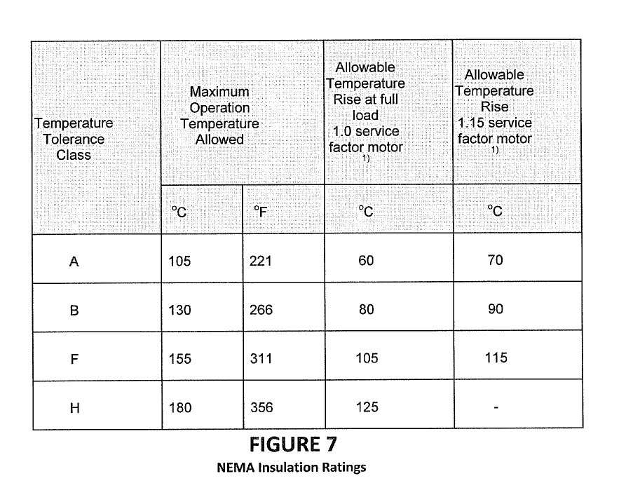

A flame-resistant spun composite yarn (TY1) consisting of: two staple yarns plied and twisted together, the resulting composite yarn having a linear density of Nm 55/2 or 370 dtex of 650 twists per meter (TPM) in the S direction. FIG. 5 depicts the S direction of the plied and twisted TY1 yarn.

Another preferred embodiment of the present invention, the number of fibers constituting the two weft systems have 22 TY1 yarns and the fibers constituting the two warp systems have 38 TY1 yarns. Such difference in the yarn count of the fibers constituting the warp and weft systems is mainly due to the fact that the finer the weft weave the better thermal insulation they provide so that lower yarn count will be advantageously used for the two weft systems, which weft system predominantly appears on both the fabric sides facing away from and towards the wearer.

Accordingly, in order to further increase the insulation effect of the fabric, particularly for exposures to heat and flames in excess of three (3) seconds, the linear mass values of the fibers constituting the weft systems will be identical to those of the fibers constituting the warp system. Advantageously there is no difference on the side of the fabric facing away from or towards the wearer. FIG. 1 depicts the warp/weft weave pattern for the face of the fabric. FIG. 2 depicts the warp/weft weave pattern for the back side of the fabric. Woven fabrics can be in either a twill or rip stop weave as is known in the art.

Advantageously, the TY1 yarn for the two weft systems and the two warp system of the woven fabric or the knitted fabric according to the present invention comprise each up to 2 wt-% of antistatic fibers. The presence of such fibers enables to prevent, to dissipate or at least to strongly reduce electrical charges that may be produced on the surface of the fabric.

A second aspect of the present invention is a garment for protection against heat, flames and electric arc comprising a structure made of at least one layer of the fabric described above.

A third aspect of the present invention is a garment that comprises a layered structure comprising an internal layer, a middle layer made of a breathing waterproof material, and an outer layer made of the above-described fabric of the invention.

The internal layer can be an insulating lining made for example of a layer of two, three or more plies. The purpose of such lining is to have an additional insulating layer further protecting the wearer from the heat.

The internal layer can be made of a woven, a knitted, a non-woven fabric and composites thereof. Preferably, the internal layer is made of a fabric comprising non melt able fire resistant materials, such as a woven fabric quilted with a fleece both made of the para-aramid and meta-aramid blend described in this invention.

The garment according to the present invention can be manufactured in any possible way. It can include an additional, most internal layer made, for example, of cotton or other materials. The most internal layer is directly in contact with the wearer's skin or the wearer's underwear.

The garment according to the present invention can be of any kind including, but not limited to jackets, coats, trousers, gloves, hoods, aprons, overalls, blankets and wraps.

The invention will be further described in the following Examples.

### EXAMPLE 1

A blend of fibers, commercially available, one under the trade name Twaron poly-paraphenylene terephthalamide (para-aramid) 1.7 dtex having a cut length of TBD from AKZO, and another fiber poly-metaphenylene isophthalamide (meta-aramid) 2.2 dtex having a cut length of TBD from TBD and 2 wt-% of carbon core polyamide sheath stainless steel fibers was ring spun into a single staple yarn (Y1) using conventional staple yarn processing equipment.

The meta-aramid fibers had a cut length of 51 mm and a linear density of 1.7 dtex. The para-aramid fibers had a cut length of 50 mm and a linear density of 2.2 dtex. The anti-static fibers had a stainless steel fiber with a cut length of 40 mm and a linear density of 6.8 μm.

Y1 had a linear mass of Nm 55/1 or 185 dtex and a twist of 700 Turns Per Meter (TPM) in Z direction. FIG. 4 depicts the spin direction Z for staple yarn Y1.

Two Y1 yarns were then plied and twisted together. The resulting plied yarn (TY1) had a linear density of Nm 55/2 or 370 dtex and a twist of 650 TPM in S direction. FIG. 5 depicts the spin direction S for composite yarn TY1. TY1 was used as both the waft and warp yarn for woven fabric.

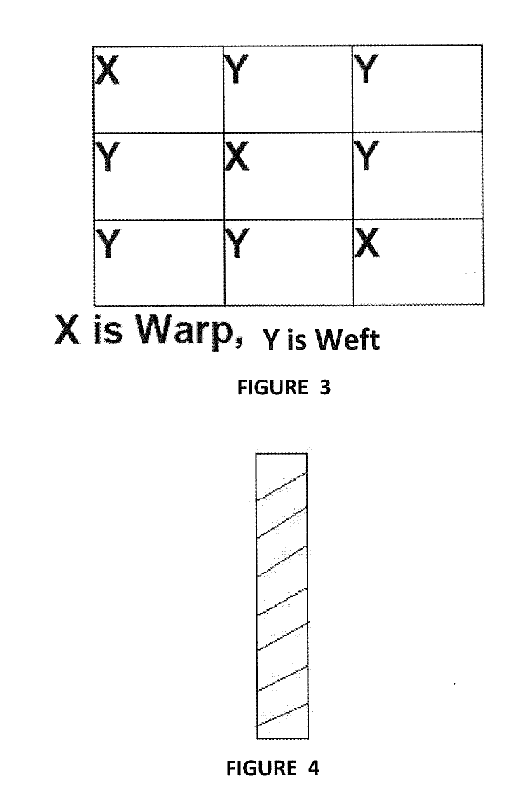

A fabric weave having a special weave plan as described in FIG. 2 and FIG. 3 was prepared. This fabric had 38 yarns/cm (warp) of TY1 (19 yarns/cm per ply), 22 yarns/cm (weft) of TY1 (11 yarns/cm per ply) and a specific weight of 230 g/m² according to the 2/1 right twill construction. The woven fabric was tested for shrinkage after 5 launderings using ISO 6330:2000. The warp shrank 1% and the weft shrank 1.2%.

The following physical tests were carried out on the fabric described in this Example 1: Determination of the breaking strength of the warp was 1619 N and the weft was 1141 N and was conducted using ISO 13934-1:1999 test procedure. Determination of the tear resistance of the warp was 67.87 N and the weft was 34.4 N and was conducted using ISO 13937-1:2000 test procedure.

Samples were sent to a US Government certified testing lab for the following test results in Reports 1 through 8. In every case the invention exceeded the certification requirements and surpassed the test results for the current state of the art in fabrics of similar fabric weight comprised of the same materials of construction:
Report 1: Fabric of Invention 12 second vertical flammability, NFPA 70:2009 Standard for Electrical Safety in the Workplace, ASTM D 6413 Standard Test Method Flame Resistance of Textiles (Vertical Test) and ASTM F 1506 Standard Performance Specification for Flame Resistant Textile Materials for Wearing Apparel for Use by Electrical Workers Exposed to Momentary Electric Arc and Related Thermal Hazards paragraph 130.7. The material weight was 7.4 oz/yd. The tests were performed prior to laundering as a reference point for subsequent tests after 25 and 100 launderings. 10 specimens of the woven fabric were tested according to the following criteria with the corresponding results:
   5 specimens were tested lengthwise and 5 specimens were tested widthwise.
   After 12 seconds of a calibrated flame:
      There was no after flame for all 10 samples (2 seconds is the allowable limit)
      There was no afterglow for all 10 samples
      The allowable char length for the test is 152 mm
         The 5 lengthwise specimens averages 17 mm (roughly 10% of the allowable limit)
         The 5 widthwise specimens averaged 15 mm (roughly 10% of the allowable limit)
      There was no melting or dripping
Report 2: Fabric of Invention 12 second vertical flammability, NFPA 70:2009 Standard for Electrical Safety in the Workplace, ASTM D 6413 Standard Test Method Flame Resistance of Textiles (Vertical Test) and ASTM F 1506 Standard Performance Specification for Flame Resistant Textile Materials for Wearing Apparel for Use by Electrical Workers Exposed to Momentary Electric Arc and Related Thermal Hazards paragraph 130.7. The material weight was 7.4 oz/yd. The tests were performed after 25 launderings according to the following criteria with the corresponding results:
   5 specimens were tested lengthwise and 5 specimens were tested widthwise.
   After 12 seconds of a calibrated flame:
      There was no after flame for all 10 samples (2 seconds is the allowable limit)
      There was no afterglow for all 10 samples
      The allowable char length for the test is 152 mm
         The 5 lengthwise specimens averages 14 mm (roughly 10% of the allowable limit)
         The 5 widthwise specimens averaged 11 mm (roughly 10% of the allowable limit)
      There was no melting or dripping
Report 3: Fabric of Invention 12 second vertical flammability, NFPA 70:2009 Standard for Electrical Safety in the Workplace, ASTM D 6413 Standard Test Method Flame Resistance of Textiles (Vertical Test) and ASTM F 1506 Standard Performance Specification for Flame Resistant Textile Materials for Wearing Apparel for Use by Electrical Workers Exposed to Momentary Electric Arc and Related Thermal Hazards paragraph 130.7. The material weight was 7.4 oz/yd. The tests were performed after 100 launderings according to the following criteria with the corresponding results:
   5 specimens were tested lengthwise and 5 specimens were tested widthwise.
   After 12 seconds of a calibrated flame:
      There was no after flame for all 10 samples (2 seconds is the allowable limit)
      There was no afterglow for all 10 samples
      The allowable char length for the test is 152 mm
         The 5 lengthwise specimens averages 24 mm (roughly 20% of the allowable limit)
         The 5 widthwise specimens averaged 18 mm (roughly 20% of the allowable limit)
      There was no melting or dripping
Report 4: Fabric of Invention Thermal Protective Performance (TPP) Test, NFPA 2112:2007 Standard on Flare Resistant Garments for Protection of Industrial Personnel Against Flash Fire, Section 8.2. The TPP value is based on a theoretical level of thermal protection based on time versus heat exposure. During the test the specimen is placed between a calibrated heat source and a calorimeter. The longer it takes the sensing calorimeter to heat up the higher the TPP value. The higher the TPP value the longer the exposure until a second degree burn is experienced. The material weight was 7.4 oz/yd. The tests were performed on new fabric and after 25 launderings according to the following criteria with the corresponding results:
   3 specimens were tested with the measurement instrument contacting the fabric and with an air gap.
   Exposure energy was calibrated at 2.0+/−0.11 cal/cm²
   Initial specimens (no laundering) were tested:
      Average value of the three specimens with air gap was 14.2 cal/cm² (allowable minimum TPP 6 cal/cm²)
      Average value of the three specimens contacting fabric was 9.1 cal/cm² (allowable minimum TPP 3 cal/cm²)
   25 Laundering specimens were tested:
      Average value of the three specimens with air gap was 14.8 cal/cm² (allowable minimum TPP 6 cal/cm²
      Average value of the three specimens contacting fabric was 10.1 cal/cm² (allowable minimum TPP 3 cal/cm²)
Report 5: Fabric of Invention Heat and Thermal Shrinkage Resistance Test, NFPA 2112:2007 Standard on Flame Resistant Garments for Protection of Industrial Personnel Against Flash Fire, Section 8.4. Three specimens were selected and were subjected to the test at three different locations 255 mm×255 mm on each specimen at 500 degrees C. This test was performed on new fabric. The requirements are that the fabric does not shrink more than 10% (25.5 mm) in any direction and shall not melt, drip, separate or ignite. The report shows that there was no shrinkage (0 mm) and no melting, dripping, separation or igniting of the fabric.
Report 6: Fabric of Invention Heat and Thermal Shrinkage Resistance Test, NFPA 2112:2007 Standard on Flame Resistant Garments for Protection of Industrial Personnel Against Flash Fire, Section 8.4. Three specimens were selected and were subjected to the test at three different locations 255 mm×255 mm on each specimen at 500 degrees C. This test was performed on fabric after 25 launderings. Note that the specification only requires 3 launderings. The requirements are that the fabric does not shrink more than 10% (25.5 mm) in any direction and shall not melt, drip, separate or ignite. The report shows that there was no shrinkage (0 mm) and no melting, dripping, separation or igniting of the fabric.
Report 7: Fabric of Invention 12 Second Vertical Flame Test FAA FAR 25.853 (a)&(b). Six specimens were selected and split between to measurement machines. The average burn length for each machine was 0.9″ and 0.7″ which was only 12% of the allowable char length for the test of 6.0″. The test results for after flame was 0 seconds against an allowable result of 15.0 seconds. The drip burn results was zero seconds against an allowable result of 5.0 seconds.
Report 8: Fabric of Invention 60 Second Vertical Flame Test FAA FAR 25.853 (a)&(b). Six specimens were selected and split between to measurement machines. The average burn length for each machine was 1.3″ and 1.5″ which was only 25% of the allowable char length for the test of 6.0″. The test results for after flame was 0 seconds against an allowable result of 15.0 seconds. The drip burn results was zero seconds against an allowable result of 5.0 seconds.

### EXAMPLE 2

### Current State of the Art

A blend of fibers, commercially available under the DuPont trade names NOMEX® (meta-aramid) and KEVLAR® (para-aramid) provided in a DuPont fabric Protera™ totaling 33 wt % NOMEX® and KEVLAR® in a single layer twill weave at 6.8 oz/sq yd, similar to, but not in the same wt % of meta-aramid and para-aramid as the invention disclosed herein.
Report 9: DuPont Protera™ 12 second vertical flammability, NFPA 70:2009 Standard for Electrical Safety in the Workplace, ASTM D 6413 Standard Test Method Flame Resistance of Textiles (Vertical Test) and ASTM F 1506 Standard Performance Specification for Flame Resistant Textile Materials for Wearing Apparel for Use by Electrical Workers Exposed to Momentary Electric Arc and Related Thermal Hazards paragraph 130.7. The material weight was 6.8 oz/yd. The tests were performed prior to laundering. 10 specimens of the woven fabric were tested according to the following criteria with the corresponding results:
   5 specimens were tested lengthwise and 5 specimens were tested widthwise.
   After 12 seconds of a calibrated flame:
      There was no after flame for all 10 samples (2 seconds is the allowable limit)
      There was an average afterglow of 2.5 seconds
      The allowable char length for the test is 152 mm
         The 5 lengthwise specimens averages 91 mm (roughly 65% of the allowable limit)
         The 5 widthwise specimens averaged 87 mm (roughly 65% of the allowable limit)
      There was no melting or dripping

The first example of current state of the art, DuPont Protera™, displayed significantly different NFPA 70E test results in fabric performance from this invention. The direct comparison between the test results for this invention in Report 1 and the test results for Dupont Protera™ shows two distinct differences in after glow and fabric char length. There was no after glow for the invention and an average after glow of 2.5 seconds for DuPont Protera™. Although the test criteria allows after glow for 10 seconds, after glow indicates that the fibers are being charred which makes the fibers brittle. The char length is the dimension for fabric that has charred. The greater the char length, the more the fabric becomes brittle and eventually the fabric breaks exposing whatever is underneath directly to flame and heat. The char length for the invention was an average of 16 mm or approximately 10% of the allowable limit for the test. The char length of Dupont Protera™ was an average of 89 mm, 5.5 times greater than the invention and 65% of the allowable limit for the test.
Report 10: DuPont Protera™ 60 Second Vertical Flame Test FAA FAR 25.853 (a)&(b). Six specimens were selected and split between to measurement machines. The average burn length for each machine was 4.3″ and 4.0″ and 70% of the allowable char length for the test of 6.0″. The test results for after flame was 0 seconds against an allowable result of 15.0 seconds. The drip burn results was zero seconds against an allowable result of 5.0 seconds.

The first example of current state of the art, DuPont Protera™, displayed significantly different FAA FAR test results in fabric performance from this invention. The difference between this test and the NFPA 70E test is that the exposure time is increased from 12 to 60 seconds and there is no measurement for after glow. In addition, the invention was tested after 100 launderings where the Dupont Protera™ was tested before laundering. The char length for the invention was an average of 1.4 in or approximately 25% of the allowable 6.0 in limit for the test. The char length of Dupont Protera™ was an average of 4.2 in, nearly 4 times greater than the invention and 70% of the allowable limit for the test.

### EXAMPLE 3

### Current State of the Art

A blend of fibers, commercially available under the DuPont trade names NOMEX® (meta-aramid) and KEVLAR® (para-aramid) provided in DuPont fabric NOMEX® IIIA totaling 93 wt % NOMEX®, 5 wt % KEVLAR® and 2 wt % anti static in a single layer twill weave at 8.0 oz/sq yd similar to, but not in the same wt % of meta-aramid and para-aramid as the invention disclosed herein.
Report 11: DuPont NOMEX® IIIA 12 second vertical flammability, NFPA 70:2009 Standard for Electrical Safety in the Workplace, ASTM D 6413 Standard Test Method Flame Resistance of Textiles (Vertical Test) and ASTM F 1506 Standard Performance Specification for Flame Resistant Textile Materials for Wearing Apparel for Use by Electrical Workers Exposed to Momentary Electric Arc and Related Thermal Hazards paragraph 130.7. The material weight was 8.0 oz/yd. The tests were performed prior to laundering. 10 specimens of the woven fabric were tested according to the following criteria with the corresponding results:
   5 specimens were tested lengthwise and 5 specimens were tested widthwise.
   After 12 seconds of a calibrated flame:
   There was no after flame for all 10 samples (2 seconds is the allowable limit)
   There was no afterglow
   The allowable char length for the test is 152 mm
   The 5 lengthwise specimens averages 66 mm (roughly 43% of the allowable limit)
   The 5 widthwise specimens averaged 58 mm (roughly 38% of the allowable limit)
   There was no melting or dripping

The second example of current state of the art, DuPont NOMEX® IIIA, displayed significantly different NFPA 70E test results in fabric performance from this invention. The direct comparison between the test results for this invention in Report 1 and the test results for DuPont NOMEX® IIIA shows a distinct difference in fabric char length. The char length is the dimension for fabric that has charred. The greater the char length, the more the fabric becomes brittle and eventually the fabric breaks exposing whatever is underneath directly to flame and heat. The char length for the invention was an average of 16 mm or approximately 10% of the allowable limit for the test. The char length of DuPont Protera™ was an average of 62 mm, nearly 4 times greater than the invention and 41% of the allowable limit for the test.
Report 12: DuPont NOMEX® IIIA 60 Second Vertical Flame Test FAA FAR 25.853 (a)&(b). Six specimens were selected and split between to measurement machines. The average burn length for each machine was 2.8″ and 3.2″ and 50% of the allowable char length for the test of 6.0″. The test results for after flame was 0 seconds against an allowable result of 15.0 seconds. The drip burn results was zero seconds against an allowable result of 5.0 seconds.

The second example of current state of the art, DuPont NOMEX® IIIA displayed significantly different FAA FAR test results in fabric performance from this invention. The difference between this test and the NFPA 70E test is that the exposure time is increased from 12 to 60 seconds and there is no measurement for after glow. In addition, the invention was tested after 100 launderings where the DuPont NOMEX® IIIA was tested before laundering. The char length for the invention was an average of 1.4 in or approximately 25% of the allowable 6.0 in limit for the test. The char length of DuPont Protera™ was an average of 3.0 in, twice the charring length of the invention and 50% of the allowable limit for the test.

The certified test results show a yarn construction when simply woven that has exceptional properties for protection from heat, flame and electric arc protection while having no shrinkage, melting, dripping, separation, after flame, after glow or ignition. In addition the test results show no degradation in protection from laundering, even at 100 laundering cycles.

The flame and heat resistance is significantly better that the current state of the art products of similar fabric weight and weave comprised of the same materials of meta-aramid and para-aramid fibers. Clearly the wt % of para-aramid as well as the unique method of making the yarn contributes to the performance of the invention disclosed herein.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. Heat, flame and electric arc protective single layer fabric for use as single layer of a protective garment for a wearer, the fabric comprising: interwoven warp and weft yarn wherein the warp and weft yarn comprises a blend of 8 to 33 wt-% Meta-aramid, poly(meta-phenyleneisophthalamide) fibers, 65 to 90 wt-% Para-aramid, poly-(p-phenylenterephtalamid) fibers, and 2 wt-% anti-static metal fibers wrapped in a carbon core polyamide sheath, the weft yarn and warp yarn being identical and comprising the side of the fabric facing away from the wearer and the side of the fabric facing the wearer, wherein the fabric provides ablative thermal protection on both sides.

2. The fabric according to claim 1, wherein the ratio between the weft yarns and warp yarns is identical, such that the total wt-% ratio between meta-aramid and para-aramid in the weft yarns is the same as the wt-% ratio between meta-aramid and para-aramid in the warp yarns.

3. The fabric according to claim 1, wherein the warp and weft yarns are, identical to each other, and are based on twisted yarns.

4. The fabric according to claim 1, wherein the warp and weft yarn is comprised of two identical staple yarns, the staple yarns having a linear mass from Nm 70/1 or 143 dtex to Nm 35/1 or 295 dtex and the warp and weft yarns being a composite yarn of two staple yarns having a linear mass from Nm 70/2 or 286 dtex to 35/2 Nm or 590 dtex.

5. The fabric according to claim 1, wherein the weft yarn and the warp yarn comprise each up to 2 wt-% of antistatic fibers.

6. The fabric according to claim 1, wherein the staple yarns are ring spun yarns.

7. The fabric according to claim 1, wherein the composite warp and weft yarns are plied and twisted staple yarns.

8. The fabric according to claim 1, having a specific weight from about 170 to 350 g/m2.

9. The fabric according to claim 1, having one composite weft yarn identical to the warp yarn.

10. The fabric according to claim 1, is a dual ply, where the weave fabric has a warp with 38 ends per cm, 19 ends for each ply, and 22 ends per cm, 11 ends for each ply according to a standard 2/1 right twill or rip stop construction.

11. Garment for protection against heat and flames comprising a structure made of at least one layer of a fabric according to claim 1.

12. A flame-resistant ring spun staple yarn consisting of: 8 to 33 wt-% poly-m-phenylenisophtalamid (meta-aramid) fiber, 65 to 90 wt-% poly-p-phenylenterephtalamid (para-aramid) fiber, and 2 wt-% anti-static stainless steel fiber wrapped in a carbon core polyamide sheath with a twist from 480 to 950 turns per meter (TPM) in the Z direction.

13. A flame-resistant spun composite yarn consisting of: two staple yarns plied and twisted together, the resulting composite yarn having a linear density of Nm 55/2 or 370 dtex of 650 twists per meter (TPM) in the S direction.

14. The process to manufacture the fibrous structure of claim 12, comprising the step of processing a non composite para-aramid strand and a non composite meta-aramid strand in a parallel relationship to each other at a weight percentage ranging from 65% para-aramid/33% meta-aramid fiber/2% anti-static to 95% para-aramid fiber/8% meta-aramid/2% anti-static fiber.

15. The process of claim 14, wherein the processing includes knitting, weaving and unidirectionally laying down or combining the staple yarn with a binding matrix to form a nonwoven.

16. The process of claim 14, wherein the process is knitting.

17. The process to manufacture the fibrous structure of claim 13, comprising the step of processing a para-aramid, meta-aramid and antistatic staple yarn in a parallel relationship to each other.

18. The process of claim 17, wherein the processing includes knitting, weaving and unidirectionally laying down or combining the staple yarn with a binding matrix to form a nonwoven.

19. The process of claim 17, wherein the process is knitting.

20. Process for providing a staple yarn having flame-resistance comprising:
a. Providing staple yarn of at least non composite para-aramid fiber, meta-aramid fiber and anti-static fiber,
b. Feeding staple yarn into a knitting or weaving machine with no prior or established order,
c. Knitting or weaving the fibrous structure with no concern regarding the order that the staple yarn is fed into the knitting or weaving machine.

21. Process for providing a composite yarn having flame-resistance comprising:
a. Providing composite yarn of at least staple yarn made from para-aramid fiber, meta-aramid fiber and anti-static fiber,
b. Feeding composite yarn into a knitting or weaving machine with no prior or established order,
c. Knitting or weaving the fibrous structure with no concern regarding the order that the composite yarn is fed into the knitting or weaving machine.
